(19) United States
(12) Patent Application Publication
(10) Pub. No.: US 2004/0003248 A1
(43) Pub. Date: Jan. 1, 2004

(54) Protection of web pages using digital signatures

(75) Inventor: Mikhail Arkhipov, Woodinville, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation

(21) Appl. No.: 10/183,938

(22) Filed: Jun. 26, 2002

(51) Int. Cl. H04L 9/00

(52) U.S. Cl. 713/170

(57) ABSTRACT

A web page is published with a digital signature. The web server verifies the digital signature at runtime before sending the page over a network to a client. If the signature does not match to the document content (e.g., the decrypted document content that had been previously encoded during the signing process does not match the original never encoded clear document content), the server stops serving the page and provides an indication, such as notifying the system administrator and/or the client. The client browser also can check the signature when it gets the page. The client browser can refuse to render the page and warn the user if the digital signature does not match to the document content.

### FIELD OF THE INVENTION

This invention relates in general to the field of web page security. More particularly, this invention relates to the protection of web pages using digital signatures.

### BACKGROUND OF THE INVENTION

When a hacker breaks into a web server, he can modify web pages without authorization. For example, a hacker can inject a malicious client script to one of the web pages located on the server in order to gain control over a user's machine when the user's machine downloads the web page and executes the script. Alternately, a hacker can replace the web site content with different content, thereby providing either deliberately incorrect information such as an incorrect stock price, for example, or inappropriate material that may damage the reputation of the company owning the web site, for example.

Cryptography is the science of disguising information through the process of encryption and restoring it to its original form through the process of decryption. In a public key cryptography system, two keys (a public key and a private key) are required for two parties to exchange information in a secure fashion. If one key is used to encrypt a message, then only the other key in the pair can be used to decrypt it.

A public and private key pair is a pair of numbers and has no inherent association with any identity. In order for public key cryptography to be successful, a trusted third party is used to bind an identity to a public and private key pair. The existence of such a trusted entity prevents an individual from generating a key pair and falsely claiming to be someone else. This trusted entity is known as a certification authority. A trusted certification authority signs an electronic document that binds the identity of an individual or organization to a public key.

Although the keys of the public and private key pair are mathematically related, it is computationally infeasible to derive one key from the other, so the private key is protected from duplication or forgery even when someone knows the public key. Therefore, it is safe to openly distribute a public key for all to use, but it is essential that a private key remain closely guarded and secret. If someone wants to send an encrypted message, they encrypt the message with a public key and the sole possessor of the corresponding private key of the pair is the only one who can decrypt it.

Public key cryptography is used to ensure information privacy, but it also provides authentication. Authentication refers to the process the recipient of an electronic message would follow in order to verify the integrity of the message as well as the identity of the sender. Just as encryption is used to accomplish privacy, a digital signature is used to accomplish authentication.

Conventionally, digital signatures are created and verified using public keys, and are being used to identify authors/co-signers of electronic data. Digital signatures provide several features including (1) the ability to authenticate the identity of the signer of the data, (2) the ability to protect the integrity of the data, and (3) nonrepudiation which proves the identity of the parties that participated in the transaction. The same technology used for digital signatures, public keys, can be used to encrypt data and keep it private from all but the intended recipient.

To verify the authenticity of the signer, one may have to visit the web site of a third party certificate issuing authority and verify that the provided public key indeed belongs to the signer. The certificate issuing authority registers key owner credentials and therefore can verify whom the particular public key belongs to. Another way of verification of the signer identity is to compare the provided public encryption key to a trusted key already present in the computer. That trusted key could be obtained earlier by other means (e.g., delivered via ordinary mail, delivered as part of a separate encrypted email message, published in a newspaper, published on a secure web site, etc.).

It is thus desirable that a web page that a user is viewing contains the original information and has not been modified by a hacker. It is also desirable to know that the web page comes from the legitimate, original web site and the web site itself was not compromised.

Neither conventional web server software nor client browser software are able to detect a tampered web page prior to providing it on a user's display. It is desirable to detect a tampered web page residing on a server prior to it being downloaded to a client web browser or displayed on a user's display. A need therefore exists for a method for providing detection of unauthorized changes of the web site content.

In view of the foregoing, there is a need for systems and methods that overcome the limitations and drawbacks of the prior art.

### SUMMARY OF THE INVENTION

The present invention detects unauthorized changes to the web page document using digital signatures in conjunction with the web page. More particularly, the present invention is directed to systems and methods that provide verification and authentication of web site content by using digital signatures. The web server or the client browser will detect tampering or modification of the web site content. The security techniques of the present invention can be implemented in both web server software and client web browser software.

According to an embodiment of the invention, a web server verifies a digital signature at runtime before sending a web page over a network to a client. If the signature does not match to the document content (which means that the document has changed), the server stops serving the page and provides an indication, for example, to the system administrator and/or the user attempting to access the web page.

According to aspects of the invention, the client browser checks the digital signature when it gets the page. The client browser can refuse to render the page and warn the user if the digital signature does not match to the document content.

When a web page is published and placed on a web server, it is digitally signed using a private encryption key and the digital signature is placed on the page. When a client web browser program requests the page from the web server, the server first verifies the digital signature in order to ensure that the page was not modified without authorization. When the web page contains server-side processing scripts, the final page content is also digitally signed before it is delivered to the client machine.

According to further aspects of the invention, if the web page does not contain a digital signature (when, for instance, it comes from an older web server that does not implement the described digital signature verification mechanism), the client browser displays a warning indicator to advise the user that the web page content could not be verified.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a flow diagram showing an exemplary web page publishing process in accordance with the present invention;

FIG. 3 is a flow diagram showing an exemplary web page serving process in accordance with the present invention;

FIG. 4 is a flow diagram showing an exemplary web page serving process with server-side processing in accordance with the present invention; and

FIG. 5 is a flow diagram showing an exemplary method of web page content verification in accordance with the present invention.

### DETAILED DESCRIPTION OF PREFERRED EMBODIMENTS

Overview

When hacker breaks into a web server, he can modify web pages and add a malicious client script or replace the site content (e.g., deface the site). The present invention detects unauthorized changes to the document using digital signatures in conjunction with the web page. More particularly, the present invention is directed to systems and methods that provide verification and authentication of web site content by using digital signatures. Even if a hacker is able to break into a web site and attempts to modify a web page (or even succeeds in doing so), the web server or the client browser will detect the tampering and not permit the modified web page content to be provided to the client browser and/or displayed by the client browser. The security techniques of the present invention can be implemented in both web server software and client web browser software.

A web server verifies a digital signature at runtime before sending the page over a network to a client. If the signature does not match to the document content (e.g., the decrypted document content that had been previously encoded during the signing process does not match the original never encoded clear document content), the server can stop serving the page and would provide an indication, such as notifying the system administrator and/or the client.

The client browser also can check the signature when it gets the page. The client browser can then refuse to render the page and warn the user if the digital signature does not match to the document content.

When a web page is published and placed on a web server, it is digitally signed using a private encryption key and the digital signature is placed on the page. In such a manner, the web page now contains the original clear document content and encrypted document content. When a client web browser program requests the page from the web server, the server first verifies the digital signature in order to ensure that the page was not modified without authorization. This is performed by, for example, decrypting the encrypted document content and comparing it to the original clear document content. If there is a match, then it is understood that the document content has not been altered or otherwise modified since it had been signed. When the web page contains server-side processing scripts, the final page content is also digitally signed before it is delivered to the client machine.

The client web browsing software checks the signature on the page before displaying it to the user. If the signature does not match the document content, the client web browser can choose to refuse to render the page and warn the user that the page may have been tampered.

If the page does not contain a digital signature (when, for instance, it comes from an older web server that does not implement the described digital signature verification mechanism), the client browser can display a warning indicator to advise the user that the page content could not be verified.

Exemplary Computing Environment

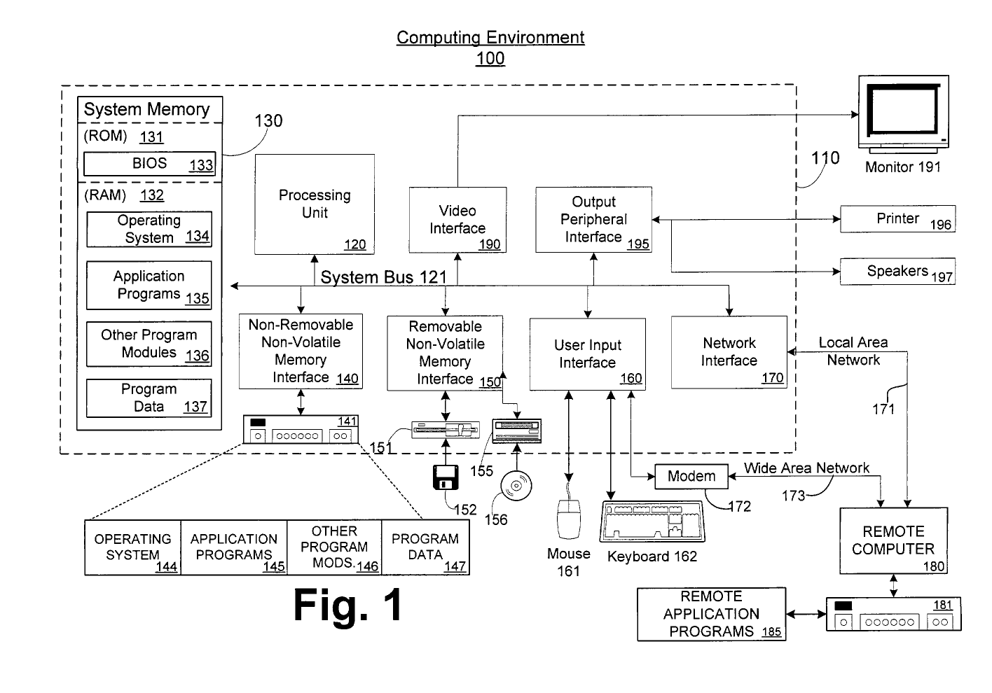

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, nonvolatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Distributed Computing Frameworks or Architectures

Various distributed computing frameworks have been and are being developed in light of the convergence of personal computing and the Internet. Individuals and business users alike are provided with a seamlessly interoperable and web-enabled interface for applications and computing devices, making computing activities increasingly web browser or network-oriented.

For example, MICROSOFT®'s .NET platform includes servers, building-block services, such as web-based data storage and downloadable device software. Generally speaking, the .NET platform provides (1) the ability to make the entire range of computing devices work together and to have user information automatically updated and synchronized on all of them,(2) increased interactive capability for web sites, enabled by greater use of XML rather than HTML, (3) online services that feature customized access and delivery of products and services to the user from a central starting point for the management of various applications, such as e-mail, for example, or software, such as Office .NET, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While exemplary embodiments herein are described in connection with software residing on a computing device, one or more portions of the invention may also be implemented via an operating system, application programming interface (API) or a “middle man” object between a coprocessor and requesting object, such that services may be performed by, supported in, or accessed via all of NET's languages and services, and in other distributed computing frameworks as well.

Exemplary Embodiments

The present invention provides detection of unauthorized changes to web site content by implementing detection of the change on a web server and/or in the client web browser or other software program that downloads and presents the web page to the end user.

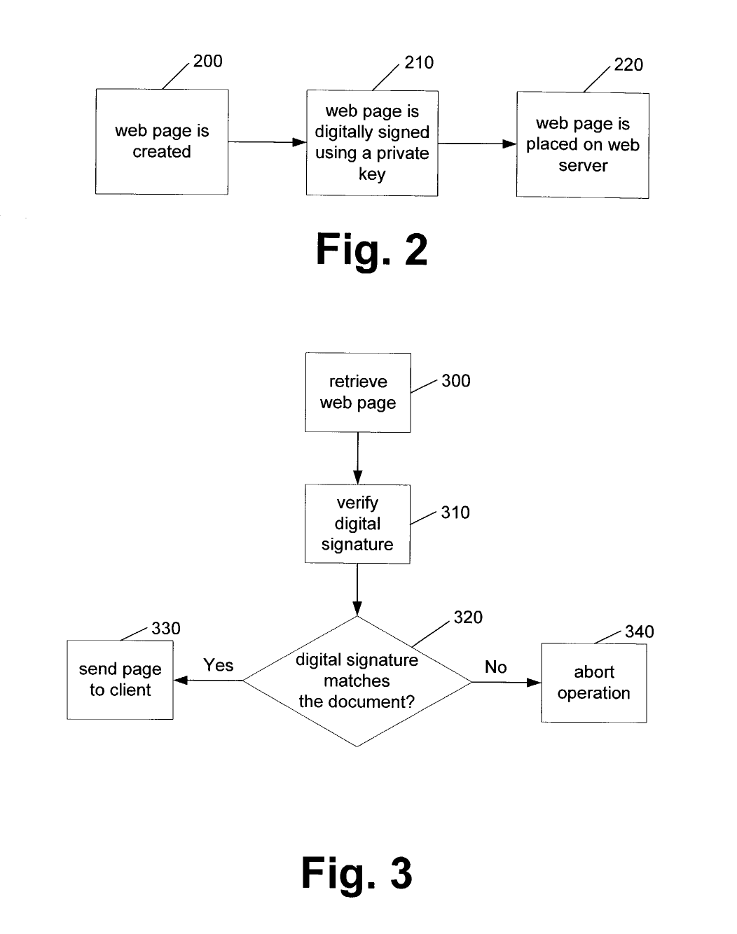

FIG. 2 is a flow diagram showing an exemplary web page publishing process in accordance with the present invention. At step 200, a web page is created, by a web designer for example, and then digitally signed at step 210 using a private key. The private key can be, for example, a private key of the company hosting the web page. It is contemplated that any conventional signing technique can be used to digitally sign the web page. A preferred way to create a digital signature is to create a “hash”, a probabilistically unique shortened version of the web page, and then use a private encryption key to encrypt the hash. The encrypted hash is the digital signature. The digital signature is unique to both the page content and the private key used to create it, so it cannot be forged. The digital signature is then appended to the web page.

At step 220, the web page is placed on the web server, where it can then be accessed by a client web browser. At this point, the web page contains the digital signature (e.g., the encrypted hash of the web page content), and the original clear web page content. Subsequently, as described below, verification and authentication of the web page content will be performed by comparing the web page content that had been encrypted (and then decrypted) with the original web page content.

More particularly, according to an embodiment, the entire content is not compared. Instead, a digital signature (which is preferably an encrypted hash) is determined from the document content. Thus, a decrypted hash is compared to the hash calculated from the clear content. Accordingly, content is transmitted unencrypted, and only a hash is encrypted. A public key is used to decrypt the hash. Then another hash is calculated from the clear content. The two hashes are compared and if equal, the clear content is considered authentic.

Thus, when a web page is published and placed on the web server, it is digitally signed, preferably using a private encryption key. Desirably, the digital signature is placed on the page within an HTML comment block or within another place on the page that is not normally displayed in the client web browser, such as an XML island, or other invisible text. The page can be digitally signed by a web development tool during the page deployment on the server or by a separate software program that can be executed after the final version of the page is ready for publishing.

FIG. 3 is a flow diagram showing an exemplary web page serving process in accordance with the present invention. When a client web browser program requests the page from a web server, the server retrieves the web page from storage at step 300, and verifies the digital signature of the web page at step 310 in order to ensure that the page was not modified without authorization. More particularly, the web page hash that had been encrypted is decrypted and compared to the original hash which, at this step, is determined from the page content again.

If the digital signature (decrypted web page hash) matches the original document content at step 320, the server transmits the web page to the client at step 330. The web page can be transmitted to the client without a digital signature, in which case the client's browser displays the web content without any additional verification/authentication processing. Alternately, the web page can be transmitted to the client with the digital signature, in which case the client can locally perform verification/authentication processing prior to displaying the web page content to the user.

However, if there is no match at step 320, the operation is aborted at step 340. At this point, the server stops serving the web page and optionally notifies the system administrator or performs other predetermined tasks as defined by the system administrator for that particular case. Additionally, the client can be notified of the digital signature mismatch and alerted as to the reason the operation has aborted. In this manner, an indication is provided to the user instead of the unverified web page.

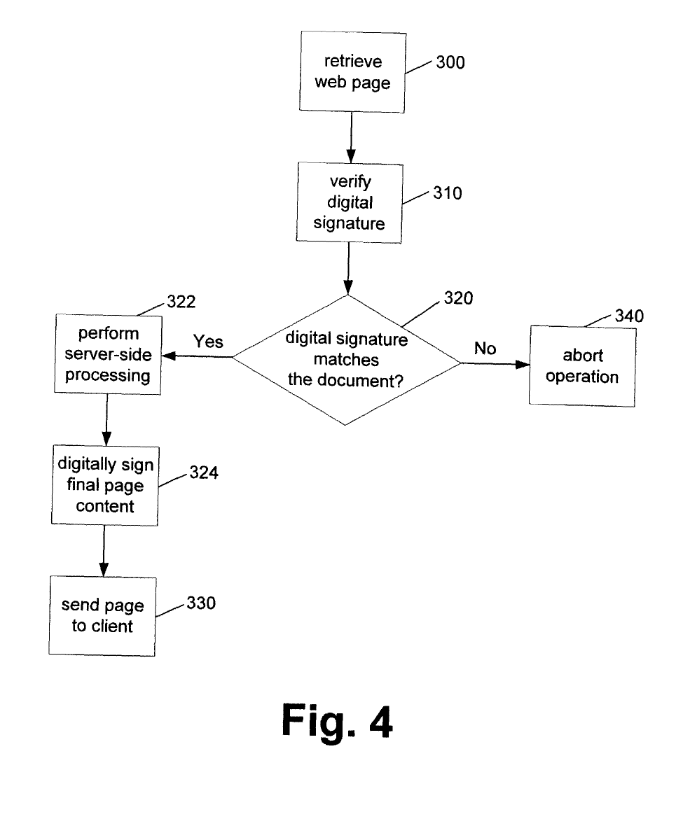

When the web page contains server-side processing scripts such as Active Server Page (ASP) script or ASP.NET scripts or objects that generate actual page content at runtime, additional steps are desirably performed. FIG. 4 is a flow diagram showing an exemplary web page serving process with server-side processing in accordance with the present invention. FIG. 4 contains steps similar to those described above with respect to FIG. 3. These steps are labeled identically and their description is omitted for brevity. After the digital signature is verified at steps 310, 320, the server-side scripts are executed at step 322. After the server-side processing is performed, and the final content of the page is ready, the page is digitally signed at step 324, and then delivered to the client machine at step 330. In such a case, the client receives a digitally signed web page that can be authenticated by the client.

Upon receiving the data, the client web browsing software checks the digital signature on the page before displaying the page to the user. This guards against unauthorized modification of the page on its way from the server to the client and protects against possible server malfunction or malicious disabling of the part of the server software program that performs the digital signature verification.

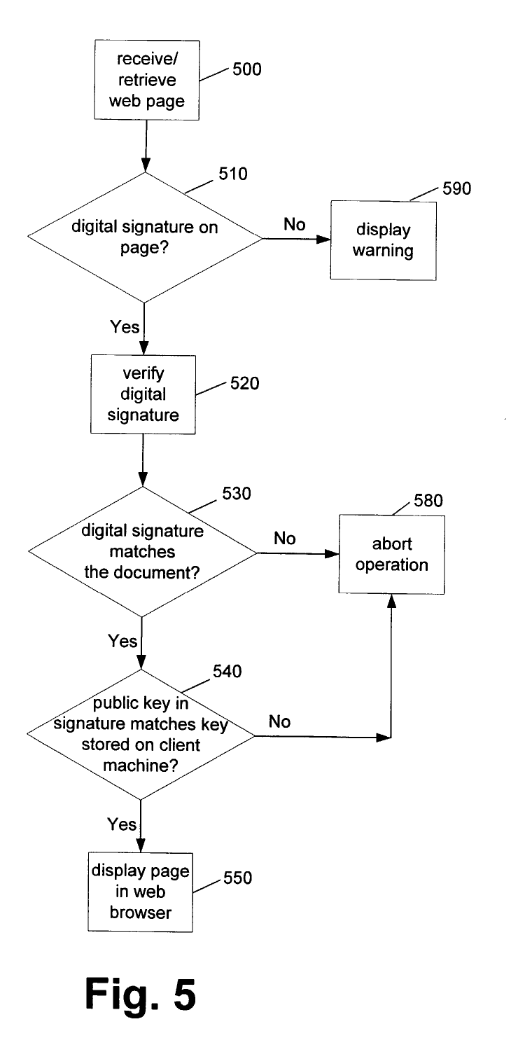

FIG. 5 is a flow diagram showing an exemplary method of web page content verification in accordance with the present invention. At step 500, a client web browser receives or retrieves the web page and determines at step 510 whether there is a digital signature present on the page. If the page does not contain digital signature (when, for instance, it comes from an older web server that does not implement a digital signature verification mechanism), the client browser can display a warning or other indicator to alert the user that the page content authenticity could not be verified, at step 590.

At step 520, the web page digital signature is verified by decrypting the encrypted content and comparing it to the original, unencrypted content on the web page. If the there is not a match, at step 530, the client web browser can refuse to render the page and warn the user that the page may be tampered, at step 580, or can render the page with a warning to the user.

The client web browsing software can also verify that the public key that comes in the digital signature of the web page actually matches the original publisher's public key stored on the client machine. In such a case, if the digital signature matches the document, at step 530, it is determined at step 540 if the public key in the signature matches the public key stored on the client machine. If so, the page is displayed in the web browser at step 550. If not, the client web browser can refuse to render the page and warn the user that the page may be tampered, at step 580, or can render the page with a warning to the user.

Thus, according to an embodiment, a message author uses his private key to encrypt a hash value. The encrypted hash is attached to the clear message along with the public key. The message receiver (a) decrypts the attached signature using the public key which gives the receiver hash created by the message author and then (b) determines another hash from the clear content using the same procedure as the one used by the message author. Two hashes are compared and if equal, the clear content is considered authentic. The attached public key is then used to verify the author identity. The above steps guarantee that message comes from the author with verified identity and the message is indeed authentic. If the hashes are not equal, it is determined that the message has been modified during the transmission. If the hashes are equal but the public key does not identify the correct author, the message is considered to be unchanged, but signed by an unknown (unauthorized) person, and, therefore, cannot be trusted.

Thus, the signer can be identified, and the verification can be provided that the content was not been changed. The content is identified in a sense that it is authentic, i.e., delivered in the original form as written by the signer.

As an example, assume a stockholder in a company receives an email message that claims that the board of directors decided to declare a stock split. The message is digitally signed (i.e., has an attached public key along with the encrypted hash). The email software decrypts the hash using the attached public key, calculates a new hash value, and compares the hash values. If the hashes are equal, verification that the attached public key belongs to the company proceeds. A third party authority web site is accessed to verify that the key is indeed registered to the company. The message is, therefore, authentic.

As another example, assume a stockholder in a company receives an email message that says that a new press release is posted on the company web site. The stockholder goes to the company web site and sees that the board of directors decided to declare a stock split. The page is digitally signed (i.e., has an attached public key along with the encrypted hash). The web browser software decrypts the hash using the attached public key, determines a new hash value, and compares them. If the hashes are equal, the web browser automatically extracts company information from the third party certificate issuing authority web site and displays it in a separate window. Now the stockholder can see that the page is indeed created by the company and has not been modified since it was published. The press release is, therefore, authentic.

A public key can be delivered to a client via the Internet. In such a case, the client web browser connects to the web server, preferably using a secure protocol such as secure socket layer (SSL). The public key is retrieved and securely stored on the client computer.

Alternatively, a public key can be delivered to a client via the press or other mechanisms. For example, a key is published in a magazine or newspaper. The user then enters the key manually into his computer, where it is securely stored.

As mentioned above, while exemplary embodiments of the present invention have been described in connection with various computing devices and network architectures, the underlying concepts may be applied to any computing device or system in which it is desirable to provide protection of web page content. Thus, the techniques for web page content protection in accordance with the present invention may be applied to a variety of applications and devices. While exemplary programming languages, names and examples are chosen herein as representative of various choices, these languages, names and examples are not intended to be limiting.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the web page content protection aspects of the present invention, e.g., through the use of a data processing API or the like, are preferably implemented in a high level procedural or object oriented programming language to communicate with a computer system. However, the program(s) can be implemented in assembly or machine language, if desired. in any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, or a receiving machine having the content protection capabilities as described in exemplary embodiments above becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. In a computer system, a method of publishing web page content, comprising:
receiving original web page content;
digitally signing the original web page content; and
storing the digitally signed web page content in a storage device.

2. The method of claim 1, wherein receiving the original web page content comprises generating the original web page content.

3. The method of claim 1, wherein digitally signing the original web page content comprises encrypting a hash of the original web page content.

4. The method of claim 3, wherein storing the digitally signed web page content comprises storing the encrypted hash of the web page content and the original web page content.

5. In a computer system, a method of authenticating web page content, comprising:
receiving web page content comprising a digital signature;
analyzing the digital signature to generate a result; and
determining the authenticity of the web page content based on the result of analyzing the digital signature.

6. The method of claim 5, wherein receiving the web page content comprises at least one of retrieving the web page content from a storage device and receiving the web page content from a transmission over a network.

7. The method of claim 5, wherein analyzing the digital signature comprises decrypting previously encrypted data, the result comprising the decrypted data.

8. The method of claim 7, wherein determining the authenticity of the web page content comprises comparing the result to a hash of the original web page content.

9. The method of claim 5, further comprising transmitting the web page content to a client if the web page content is authentic, and otherwise activating an indicator.

10. The method of claim 5, further comprising:
if the web page content is authentic, determining whether the web page content comprises a processing script and if so:
performing the processing script to generate a final page content;
digitally signing the final page content; and
transmitting the digitally signed final page content to a client.

11. The method of claim 5, further comprising:
retrieving a first public key from the digital signature;
retrieving a second public key from storage; and
comparing the first public key to the second public key to authenticate the web page content.

12. The method of claim 11, further comprising displaying the web page content if the web page content is authentic.

13. The method of claim 5, wherein determining the authenticity of the web page content is performed at runtime.

14. The method of claim 13, further comprising transmitting the web page content over a network.

15. A computer-readable medium having stored thereon computer executable instructions for performing a method of publishing web page content, the method comprising:
receiving original web page content;
digitally signing the original web page content; and
storing the digitally signed web page content in a storage device.

16. The computer-readable medium of claim 15, wherein receiving the original web page content comprises generating the original web page content.

17. The computer-readable medium of claim 15, wherein digitally signing the original web page content comprises encrypting a hash of the original web page content.

18. The computer-readable medium of claim 17, wherein storing the digitally signed web page content comprises storing the encrypted hash of the web page content and the original web page content.

19. A computer-readable medium having stored thereon computer executable instructions for performing a method of authenticating web page content, comprising:
receiving web page content comprising a digital signature;
analyzing the digital signature to generate a result; and
determining the authenticity of the web page content based on the result of analyzing the digital signature.

20. The computer-readable medium of claim 19, wherein receiving web page content comprises at least one of retrieving the web page content from a storage device and receiving the web page content from a transmission over a network.

21. The computer-readable medium of claim 19, wherein analyzing the digital signature comprises decrypting previously encrypted data, the result comprising the decrypted data.

22. The computer-readable medium of claim 21, wherein determining the authenticity of the web page content comprises comparing the result to an original web page content.

23. The computer-readable medium of claim 19, having further computer-executable instructions for transmitting the web page content to a client if the web page content is authentic, and otherwise activating an indicator.

24. The computer-readable medium of claim 19, having further computer-executable instructions for:
if the web page content is authentic, determining whether the web page content comprises a processing script and if so:
performing the processing script to generate a final page content;
digitally signing the final page content; and
transmitting the digitally signed final page content to a client.

25. The computer-readable medium of claim 19, having further computer-executable instructions for:
retrieving a first public key from the digital signature;
retrieving a second public key from storage; and
comparing the first public key to the second public key to authenticate the web page content.

26. The computer-readable medium of claim 25, having further computer-executable instructions for displaying the web page content if the web page content is authentic.

27. The computer-readable medium of claim 19, wherein determining the authenticity of the web page content is performed at runtime.

28. The computer-readable medium of claim 27, having further computer-executable instructions for transmitting the web page content over a network.

29. A system for securing web page content, comprising:
a module that receives web page content;
a processor that digitally signs the web page content; and
a storage device that stores the digitally signed web page content.

30. The system of claim 29, wherein the processor analyzes the digitally signed web page content to authenticate the web page content.

31. The system of claim 30, wherein the processor analyzes the digitally signed web page content at runtime.

32. The system of claim 30, further comprising an indicator that is activated if the web page content is unauthentic.

33. The system of claim 29, wherein the module receives the web page content from at least one of a second storage device and a transmission over a network.

34. The system of claim 29, further comprising a transmission device that transmits the digitally signed web page content over a network to a client computer.

35. The system of claim 29, wherein the processor performs a processing script on the web page content to generate a final page content and digitally signs the final page content.

36. A system for securing web page content, comprising:
a module that receives digitally signed web page content;
a processor that authenticates the digitally signed web page content and decrypts the digitally signed web page content; and
a display device that displays the decrypted web page content if the digitally signed web page content is authentic.

37. The system of claim 36, further comprising a storage device that stores a second public key, wherein the processor retrieves a first public key from the digitally signed web page content, retrieves the second public key from the storage device, and compares the first public key to the second public key to authenticate the digitally signed web page content.

38. The system of claim 36, wherein the processor authenticates the digitally signed web page content at runtime.
